(19) United States
(12) Patent Application Publication
(10) Pub. No.: US 2008/0228865 A1
(43) Pub. Date: Sep. 18, 2008

(54) Electronic personal computing and videophone system consisting of a remote server system providing dynamic, subscription based virtual computing services & resources, a thin client hardware device connected to a television set and wireless keyboard & mouse, and a wireless mobile device (a Pocket PC Phone)

(76) Inventor: Nazareno Brier Cruzada, Miami Beach, FL (US)

Correspondence Address: NAZARENO CRUZADA, 1330 SW 104TH PATH # 210, MIAMI, FL, 33174, US

(21) Appl. No.: 11/686,403

(22) Filed: Mar. 15, 2007

(51) Int. Cl. G06F 15/16; G06F 1/16

(52) U.S. Cl. 709/203; 361/683

(57) ABSTRACT

This invention is an Electronic Personal Computing and VideoPhone System Composed of:
1. a Remote Online Server System That Provides Virtual Subscription-based Computing Resources, Computer Programs, Internet-based Television Programming, Web-Based Video, Television Programming Video Card Technology, Multi-location/Multi-Point Video Conferencing Programs, Data Storage, Usage Tracking, and Video, Text & Sound Feed.
2. a Hardware Device Utilizing Software Programs To: Output Video and Sound To A TV Set; Receive User Input From a Wireless Keyboard and Mouse; Output Light, Motion and Sound Signals to Light Emitting, Motion and Sound Devices; Connect and Communicate With A Remote Online Server System; Receive Computing Services From a Virtual Computing Instance On A Remote Server; Output to a Printing Device; Input from a Scanning Device; Input from a Microphone; Input from a Video Camera; Output to Speakers; and Input/Output to a DVD/CD Drive
3. a Wireless Mobile Electronic Device Composed of a Housing, an Electronic Circuit Board, a Flash Memory, an LCD screen, a Keyboard, a Mouse, a Microphone, Speakers, a Camera, and a Software Program that Connects and Communicates With The Remote Online Server System To Send Computing Commands and Audio/Video Data and to Receive Computing Services and Audio/Video Data From a Virtual Computing Instance On A Remote Server.

### BACKGROUND OF THE INVENTION

1. Field of the Invention

Information technology and electronic computing has become ubiquitous in people's lives today. Powerful personal computers (PCs), personal digital assistants (PDAs), Pocket PCs, and SmartPhones are utilized by more and more people everyday. This increasing trend has several negative impacts on both the environment as well as the general public.

One such impact is the increase in energy usage. As these devices—especially home personal computers—need more and more powerful processors, energy consumption also increases. This increase in the consumption of electricity will put upward pressure on energy production, which in turn can increase carbon dioxide (CO2) emissions, a major environmental problem around the world. Another environmental impact is the increase in toxic electronic device waste. This is due to the increased use of materials that are not environmentally friendly such as those used in the manufacture of electronic components of these devices. Several governmental initiatives such as the Restriction of Hazardous Substances Directive (RoHS) and the Waste Electrical and Electronic Equipment Directive (WEEE) have been set in place to help solve this problem but adherence to these directives is the key to solving it. For now, as these electronic devices come to the end of their useful lives, the disposal of their carcasses is having a big environmental impact in the huge increase in landfill pollution of toxic electronic device waste.

Another impact of the ubiquity of more powerful and complex home PCs and personal electronic devices is on the wallet of consumers. As the demand for more powerful computing capabilities increase, the current trend is for computer manufacturers to build PCs with more powerful processors, motherboard components, and peripherals. It is not atypical for a home personal computer to have multiple dual core high performance processors, high performance video and audio cards, and complex motherboard architectures. Also, manufacturers of mobile electronic devices need to install computing programs similar to those provided in the user's personal computer as well as programs that synchronize data between the two devices. This creates unnecessary complexity in the computing architecture of and between these devices and introduces unnecessary complexity in their use. The need for PCs, PDAs, and mobile phones to be powerful enough to handle the increasing processing demand forces the use of additional materials, parts and labor in their manufacture, in turn increasing the price of the device which consumers ultimately pay via higher prices, which may also increase inflation.

Furthermore, archaic elements still remain in the design and manufacture of personal computing devices. For one, the typical embodiment of a home personal computer (PC) is still that of a central processing unit (a CPU) connected to a video monitor, a keyboard & mouse, and peripherals such as CD/DVD drives, a printer, or a scanner. The CPU is comprised of a high power/high performance processor or processors, a complex motherboard, a powerful internal power supply, cooling fans, high performance peripheral video and sound cards, and random access memory (RAM) attached to a motherboard that provides connections for the video monitor, disk drives, and peripherals via wires, cables, or ports.

Because of the need for this design to have a video monitor and expensive computing/processing components to be installed locally in the CPU, the cost of buying and maintaining a home personal computer can be a quite significant amount—currently as high as several thousand dollars in today's market. The significant financial amount needed to purchase and maintain a home personal computer has kept some members of the population such as high school or college students on a budget and low-income families from enjoying the benefits of owning one. Even PC buyers who can afford the price of a PC at today's market prices would more than gladly welcome and benefit from lower priced personal computers.

Also, since the inception of the home personal computer, the design or “form factor” of the CPU has basically stayed the same: a box-shaped unit. Although some CPU manufacturers such as Alienware (www.alienware.com), ColorWare (www.colorwarepc.com), Cenio (www.cenio.com), and VoodooPC (www.voodoopc.com) have provided customizations such as providing different colors and superficial variations on the shape of the CPU, its overall form factor has stayed in the shape of a box. Furthermore, the design of the CPU form factor does not allow people to customize it. Because of this, people looking to purchase a home PC do not have a wide variety of choices in buying one that fits their tastes and likes. As an example, it is not possible at this time to purchase a home PC with a CPU in the shape of a mailbox, a clamshell or a race car. It is also not possible at this time to purchase a home PC with a CPU housing that has the extensibility design similar to a Lego building set where pieces can be added on providing unlimited variations in form embodiments that people can create to tailor their PC appearance and activity to their tastes and likes.

2. Description of the Prior Art

(pls refer to Accelerated Examination Support Document)

### SUMMARY OF THE INVENTION

This invention is an electronic personal computing and videophone system consisting of a remote server system providing dynamic subscription based virtual computing services & resources, a thin client system located in the vicinity of a television set, and a wireless mobile device (a Pocket PC Phone). Users can define & create one or more virtual PCs using the remote server system and connect to it using either device. The thin client utilizes a television set as the video output; receives user input via a wireless keyboard (WiFi, BlueTooth, Infrared, etc.), a wireless mouse, attached CD/DVD drive, or attached scanner. The thin client has a software program that connects and communicates with the remote server system, which provides virtual subscription-based computing, processing, internet-based television programming, web-based video, television programming video card technology, multi-location/multi-point video conferencing programs, and data storage—in essence, a virtual computer.

Since the virtual computer is located on the remote server system, the user can use a similar software program in the wireless mobile device to access the same virtual computer he/she accesses from the home based thin client, eliminating the need for the purchase and installation of a duplicate set of similar programs onto the wireless mobile device and for programs to synchronize data from the wireless mobile device with the user's personal computer. The wireless mobile device has an LCD screen, a keyboard, a mouse, speakers, a camera, and a software program that connects and communicates with the remote server system to send computing commands and audio/video data and receives computing services and audio/video data from a virtual computer hosted on the remote server system.

Since one of the programs provided in the virtual computer is a multi-location/multi-point video conferencing program that allows a plurality of users to talk and see each other simultaneously, and since the thin client device and the wireless mobile device both have a microphone, speakers, and a video camera, both devices serve the functionality of being a personal computer as well as a videophone in one device and furthermore, for the wireless mobile device having the spirit and goal of being a Pocket PC Phone.

In this embodiment, the invention addresses and improves upon several shortcomings of current personal computing systems.

First, the invention eliminates the need for several components typical to the embodiment of a home personal computer such as the video monitor, a complex motherboard, a powerful internal power supply, cooling fans, high performance peripheral video and sound cards, and local hard drives. By utilizing a television set as the device for video output it eliminates the need to purchase a separate video monitor.

Furthermore, by connecting to and communicating with a remote server system that creates and hosts individual virtual desktop environments personalized for each thin client device or Pocket PC Phone request, these devices can be provided with personalized & customized virtual subscription-based computing resources, computer programs, data storage, and video & sound output. This subscription-based server-based computing architecture eliminates the need for a lot of expensive, energy consuming, and environmentally harmful components to be included in the manufacture of a home personal computer as well as expensive maintenance and upgrades inherent to today's PCs. This lessens the total cost to the user, lessens energy consumption since thin client devices usually use less than 1/10 the power used by regular PC processors (compare the AMD Geode which uses less than 2 watts over the Intel Pentium 4 which uses up to 85 watts), and lessens the environmental impact from toxic electronic device waste, especially in the disposal of old monitors and CPUs since this invention uses a television set instead of a monitor and a thin client device that is ⅕ the size of a regular PC. And since the thin client device does not have a hard disk drive, cooling fans, and the need for a complex and large power supply, these devices last much longer than traditional PCs.

Secondly, by utilizing a thin client device and a remote online server system in a server-based computing architecture, the invention eliminates the need for the components mentioned above to be installed locally in a CPU and in doing so it frees up the design, form factor, and space limits imposed by the existence of these components. As such, the invention's form factor can be created in shapes and materials that would not be possible with the limits imposed by the existence of these components. With this invention, the thin client device can be manufactured in a wide array of designs and shapes that cater to a wide array of people's tastes and likes. Also, the thin client device can be manufactured in a form factor that allows extensions to be added or connected to it, providing people to customize it to their own liking and improve the user experience with personal computers.

Thirdly, since the thin client device is located beside or in the vicinity of the television set, this allows the device to emit light, motion, or sound alerts to the user if and when messages arrive. These messages can include email, instant messages (IM), or system generated messages. These alerts can especially be helpful if the user is watching the television set in regular TV mode, e.g. watching a show on a TV channel. And by providing electronic ports and interfaces that light, motion, and sound devices can connect to and communicate with, the invention provides a way to further customize the user experience by providing the ability for these light, motion, and sound devices to alert the user of any incoming messages in a customized and unique fashion.

Finally, since both the home thin client device and the Pocket PC Phone serve the functionality of being a personal computer as well as a videophone in one device, the manufacture of the Pocket PC Phone becomes simplified and less costly since it does not have the need for complex high performance hardware components as well as the installation of a duplicate set of software programs to provide the functionality of those installed on the home PC and for software programs to provide complex synchronicity with the home PC programs.

In summary, by utilizing a remote online server system providing dynamic virtual computing services in a subscription-based and server-based computing architecture, the invention eliminates the need for expensive components in the manufacture of personal computers, thereby significantly lowering the manufacturing cost. This cost savings can then be passed on to the end user or consumer. This also lowers the energy consumption and the negative environmental impact from the early and unneeded disposal of toxic electronic device waste. By providing access to the virtual computer from either the home thin client or the Pocket PC Phone, the user is provided with a unified virtual computing platform and can access it either from home or on the go. Furthermore, the ability to manufacture a personal computer in a multitude of form factors, materials, or shapes that can be tailored to the different tastes and likes of people and for the PC to operate and interact with the user in ways that can be customized for individual user's tastes and likes will contribute to a unique, novel, convenient, and improved user experience with personal computers as well as give them the ability to express their unique individual tastes in their purchase and use of one.

### DETAILED DESCRIPTION OF THE INVENTION

This invention is an electronic personal computing and videophone system that is composed of several components.

One of the components is a remote online server system that creates, hosts and manages a plurality of individual virtual computing environments. This system is comprised of several sub-groups of servers. One sub-group is the system management servers, which run software programs to manage and administrate the entire remote online server system. Another sub-group is the virtual computing environment servers, which creates and hosts the plurality of virtual computing environment instances. This remote online server system also includes other network appliances and programs typical to running an efficient and safe server and network system. Such appliances include a firewall, server maintenance and administration devices and programs, as well as routers and network hubs.

Another component is a hardware device (referred to as a thin client) located locally and composed of:
1. a housing with a plurality of embodiment form factors and materials
2. an electronic flash memory card or circuit board
3. electronic ports

This hardware device uses software programs to accomplish several tasks. These tasks may include:
1. Receive user input from a wireless (WiFi, BlueTooth, Infrared, etc.) keyboard and mouse
2. Connect and communicate with the remote online server system hosting and providing a virtual computing process and environment
3. Convert PC video format to TV video format and output video to a TV set
4. Input high quality sound from microphone
5. Output high quality audio signals to speakers
6. Input/Output to a DVD/CD Drive.
7. Output light, motion and sound signals to light emitting, motion and sound devices
8. Output to a printing device
9. Input from a scanning device

With the popularity of high-definition plasma and liquid crystal display (LCD) television sets, the said thin client device may not need to convert PC image output to TV image output if the user chooses to connect to these type of TVs since the plasma and LCD televisions support the presentation of regular unconverted PC image output—usually in the format of VGA or SVGA.

Yet another component is a wireless mobile device, which contains a similar software program to the one in the thin client device to access the same virtual computer accessed from the home based thin client. This eliminates the need for the purchase and installation of a duplicate set of similar programs onto the wireless mobile device and for programs to synchronize data from the wireless mobile device with the user's personal computer. The wireless mobile device has a flash memory drive, an electronic circuit board, an LCD screen, a keyboard, a mouse, speakers, a camera, and a software program that connects and communicates with the remote server system to send computing commands and audio/video data and receives computing services and audio/video data from a virtual computer hosted on the remote server system. This makes the wireless mobile device a ‘Pocket PC Phone’ in spirit and goal.

With this computing architecture, the thin client device and Pocket PC Phone can be provided with virtual personalized subscription-based computing resources, computer programs, internet-based television programming, web-based video, television programming video card technology (e.g. ATI All-In-Wonder Radeon Pro Video Card), multi-location/multi-point video conferencing programs, data storage, service usage tracking (by the minute or hour), service subscription membership account information view and update capabilities, and video, text & sound feed. Both devices connect and communicate with this remote online server system via a plurality of internet or a private network communication link options using a remote desktop or virtual computing communications protocol wherein the thin client device captures user input from the remote keyboard and mouse or from a plurality of attached peripheral devices such as a CD/DVD drive or a scanner or for the Pocket PC Phone to capture user input from the attached keyboard & mouse, an attached microphone, or an attached video camera, then electronically sends this input to the remote online server system for computing or processing, and receives video and/or audio input back showing the computing or processing status or end result. Furthermore, this subscription-based and server-based computing architecture eliminates the need for a lot of expensive, energy consuming, and environmentally harmful components to be included in the manufacture of a home personal computer as well as expensive maintenance and upgrades inherent to today's PCs. This lessens the total cost to the user, lessens energy consumption since thin client devices usually use less than 1/10 the power used by regular PC processors (compare the AMD Geode which uses less than 2 watts over the Intel Pentium 4 which uses up to 85 watts), and lessens the environmental impact from toxic electronic device waste, especially in the disposal of old monitors and CPUs since this invention uses a television set instead of a monitor and a thin client device that is ⅕ the size of a regular PC. And since the thin client device does not have a hard disk drive, cooling fans, and the need for a complex and large power supply, these devices last much longer than traditional PCs.

The first link from the thin client device or Pocket PC Phone to the remote online server system is established when the user executes a system login and virtual computing instance requester program running on the device, which then communicates via a secure connection and protocol such as Secure Shell, Secure Sockets Layer (SSL), or Tunneling with a gateway in the remote online server system which in turn communicates with an authentication program residing in the system management servers. The information transmitted in this first link communication can include the transmission of a device ID, a Login, and password that is unique to the entire system for authentication and tracking purposes. The device ID may include information unique to the thin client device or Pocket PC Phone. The authentication program then authenticates the connection request using the ID, Login, and Password against a list of existing customers in the system. The authentication program then queries the system accounts database to retrieve the virtual machine definitions for that particular login. This is a key feature since users are allowed to create a plurality of virtual machine configuration definitions that the user had previously defined and allows them to switch and connect to an instance of these virtual machines one at a time. This list of VMs is then sent to the system login and requester program. The user can then choose from this list of virtual machine definitions and request to connect to it.

When the user chooses a specific virtual machine definition and requests to connect to it, the system login & requester program establishes a second secure link communication with the authentication program of the remote server system. A section of the authentication and tracking logic records the ID, Login, Password, and network address of the thin client or Pocket PC Phone and queries the system management program to check whether another first device is already connected and has a virtual computing session with the same login values, and if so denies the connection of the second device. This prevents users from establishing duplicate or multiple computing sessions by using both devices simultaneously. If the first device requested that the virtual computing instance to be held while the first device disconnects and the user switches devices and establishes a connection with a second device, then this is not a duplicate computing session and is therefore allowed by the system. Once this second secure link is established, a virtual computing instance creation program checks if a virtual computing instance personalized for each device is already running in one of the servers in the virtual computing environment server sub-group. If not, it dynamically creates a specific instance of that virtual computing instance. It accomplishes this by communicating with a virtual computing environment management program located in each of the servers in the virtual computing environment server sub-group. Once the virtual computing instance is created, the virtual computing instance creation program then sends the unique network address of the virtual machine to the thin client device or Pocket PC Phone. This unique network address is then received by one of the programs in either device and passed to a virtual computing instance communication & viewing program (“remote desktop client software”). The remote desktop client then communicates back to the authentication program to establish a connection to the virtual computing instance to utilize the computing, processing, and data storage services that it provides. The authentication program then verifies the network address of the thin client device or Pocket PC Phone that the remote desktop program is running on and the network address of the virtual machine that it is requesting to connect to. This provides a layer of security and ensures that only authenticated requests get connected to their appropriate virtual machines.

Since the remote online server system hosting the instance of the virtual computing environment may be located hundreds or thousands of miles away, and with the relatively large amount of data associated with sending visual images across the internet or private network, it is ideal for the embodiment of the communication link between the thin client device and the remote online server system to use broadband technology including DSL or Internet Cable service. Additionally, to provide fast and crisp image motion and refresh rates, the remote online server system will include high-performance video card or graphics processor technology.

To provide network redundancy and fault tolerance, the thin client device and the Pocket PC Phone will include functionality to choose from a plurality of internet and private network communication links to connect to the remote online server system and these plurality of communication links will be an integral part of this invention's communication network. This network and system design feature lessens the risk of communication failure over a design where only one communication link is provided. With this design, in the case that one link is down, the software program can then choose from the other available communication links to connect to the remote online server system.

To provide scalability, the remote online server system will be composed of several sub-groups of servers wherein each sub-group will include a plurality of physical server machines (a server farm or server cluster) being harnessed and managed as a group to balance the load of thin client and Pocket PC Phone requests. One of these sub-groups is the system management servers sub-group which balances the load of programs for system management, usage tracking, and dynamic creation of virtual computing instances, allowing a plurality of thin client devices to simultaneously request computing, processing, and data services. Another sub-group is the virtual computing environment servers sub-group which balances the load of hosting the plurality of virtual computing environment instances, allowing a plurality of thin client devices to simultaneously receive individual and personalized computing, processing, and data services. Yet another sub-group is the data storage servers sub-group. This sub-group is designated for a centralized persistent and permanent storage of computer data and files to allow reuse from virtual computing instances created at a future date and time.

The system management, usage tracking, virtual environment management, and virtual computing instance dynamic creation programs running in the system management servers sub-group apply logic to determine which physical server machine in the virtual computing environment servers sub-group has the appropriate and enough amount of computing, processing, or data storage resources required by each individual thin client or Pocket PC Phone request. This ensures that the computing, processing, or data storage requests from both devices do not exceed the computing, processing, or data storage resources of each physical server machine in the virtual computing environment servers sub-group.

Other components are the light, motion, and sound emitting devices that provide audio and/or visual cues or alerts of incoming messages. These devices can be built into and be part of the housing of the thin client device or be connected via one or more of the electronic ports provided for such operation. These devices can also operate separately or in unison with each other. One embodiment where these devices are built into the housing of the thin client device is that of a mailbox where the flag located on the side of the mailbox will move upwards to signal that an electronic message has arrived in the user's remote virtual computing instance. Additionally, as the flag moves upwards, an audio message can be executed, something to the effect of saying “You've got mail!”

The invention addresses and improves upon several characteristics of current home personal computing systems. Firstly, the invention eliminates the need for several components such as the video monitor, a complex motherboard, a powerful internal power supply, cooling fans, high performance peripheral video and sound cards, and local hard drives. By utilizing a television set as the device for video output it eliminates the need to purchase a separate video monitor. By connecting to and communicating with a remote online server system that creates and hosts an individual virtual desktop environment personalized for each thin client device connection, the thin client device can be provided with personalized virtual subscription-based computing resources, computer programs (such as email and web browsers), internet-based television programming, web-based video, television programming video card technology (e.g. ATI All-In-Wonder Radeon Pro Video Card), multi-location/multi-point video conferencing programs, and data storage. The thin client device sends user input that it captured from the remote keyboard or mouse, or from a peripheral attached to it such as a CD/DVD drive or scanner in order to command or request the server to do some computing or processing. The remote online server system then sends video and/or audio data to the thin client device showing the current status or end result of its computing or processing request. And since the thin client device does not have a hard disk drive, cooling fans, and the need for a complex and large power supply, these devices last much longer than traditional PCs.

When a person purchases a unit of the invention, they can choose from several pre-defined virtual computing machine configurations based on a specific computer operating system and specific sets of computer programs that are typically used for certain types of use. For example, a person who is an average user utilizing a personal computer for document editing, email, and internet browsing can choose a standard configuration which will consist of a document editor, an email program, and an internet browser. If the person is a graphics designer, then he or she can choose a configuration with graphics creation programs such as Adobe Photoshop or Macromedia Flash. If the person is a business finance professional that person can choose a configuration with a spreadsheet program and office productivity tools. If the person is looking to purchase a personal computer that is geared towards viewing television shows or videos that are available on web sites or to have access to television programming channels, he or she can choose a configuration that has a browser to view website based videos or television programming and a television programming video card such as the ATI All-In-Wonder Radeon Pro Video Card which, when installed on the remote server system and connected to a television cable service, can provide access to television programming channels that can be viewed on the user's desktop using a screen that can show multiple channels in one window. Users can also access a multi-location/multi-point video conferencing program that allows multiple people to see each other on the television and talk to each other simultaneously if they have a webcam and microphone connected to their thin client device. The invention also allows for the user to purchase and add additional computing programs or remove programs from his or her desktop environment through the user's membership account information graphical screen.

Since the remote server system is providing these subscription-based computing, processing, and data storage services, it will have a software program that will track usage, either by the minute or by the hour. This usage tracking data will record the time and date when the thin client or Pocket PC Phone device requests a connection and is granted a computing session and the time and date when it disconnects. This way, the usage data can be used to bill the user on a monthly and/or per charge basis, similar to that of cellular phone service. The usage tracking program, along with the system management program and the virtual computing environment management program will also have logic to allow the user to request the system to hold and store a particular virtual computing instance in memory for a specified amount of time so that the user can reconnect to that instance at a later time or switch devices and continue his or her session.

A website will be hosted by the remote server system to provide users access to view, edit or cancel their membership accounts by logging in using an internet browser. The remote server system will also provide the ability for users to directly access their computing and data storage service subscription membership account information from their personal computing desktop screen without having to login again. This will allow users to view and/or update their account and view their usage information just by clicking on an icon on their PC desktop. Additionally, since a plurality of thin client or Pocket PC Phone devices will be simultaneously requesting, accessing, and using the virtual computing, processing, and data storage resources of the remote online server system, the system will be composed of a plurality of physical server machines with software programs that allow the creation and hosting of a plurality of virtual computing environment instances in each physical server machine simultaneously. Furthermore, groups of physical server machines can be designated to provide specific computing, processing, and/or data storage services by configuring them to be streamlined for these specific tasks. These specific custom configurations may include those for image processing, financial data transaction processing, large database analytic processing, etc.

Secondly, by eliminating the need for the components mentioned above to be installed locally in the CPU, it frees up the design, form factor, and space limits imposed by the existence of these components. As such, the invention's form factor can be created in shapes that would not be possible with the limits imposed by the existence of these components. Form factors such as that of a miniature mailbox, a clamshell, or that of a scale model race car are possible. With this invention, the thin client device can be manufactured in a wide array of designs and shapes that cater to a wide array of people's tastes and likes. Also, the thin client device can be manufactured in a form factor that allows extensions to be added or connected to it, providing people to customize it to their own liking and improve the user experience with personal computers. These form factors include casings that have threaded fittings so that extensions can be screwed and attached to it or casings that have dovetail rails so that extensions can be slipped and attached to it.

Thirdly, since the device is located beside or in the vicinity of the television set, this allows the device to emit light, motion, or sound alerts to the user if and when messages arrive. These messages can include email, instant messages (IM), or system generated messages. By providing electronic ports and interfaces that light, motion, and sound devices can connect to and communicate with, the invention provides a way to further customize the user experience by providing the ability for these light, motion, and sound devices to alert the user of any incoming messages in a customized and unique fashion. This feature can also provide convenient and time saving benefits. An example of an embodiment of the invention that highlights this characteristic is one where the thin client device is in the shape of a small scale or miniature mailbox: one that is of the type and shape of one that stands out on a lawn, attached on top of a post, with a door on the front and a red flag on its side. This design has been emulated in images used for e-mail inboxes. It would be a smaller in scale to fit or be set on living room furniture and would have a base where the CD/DVD drive would be located (please see FIG. 2). In the event of an arrival of a message, the red flag would rise up and a prerecorded sound saying “You've got mail” would emanate from a speaker located in one of these peripheral devices. Also, the ability to operate a home PC while sitting in one's living room simply by switching from antenna or cable TV input mode to PC mode is another benefit provided by this invention. By being able to do so, the user can have immediate access to their home PC as opposed to having to go to another room where their home PC is normally located.

Another example of an embodiment of the invention is a light display similar to that of a running stock ticker tape display. In the event of an arrival of a message such as an email, the display would then show the sender's email address and the subject of the email. These light, sound, and motion alerts can notify the user of incoming messages and can especially be helpful if the user is using the television set in regular TV mode, e.g. watching a show on a TV channel. The ability to manufacture a personal computer in a multitude of form factors, materials, or shapes that can be tailored to the different tastes and likes of people and for the PC to operate and interact with the user in ways that can be customized for individual user's tastes and likes will contribute to a unique, convenient, and improved user experience with personal computers as well as give them the ability to express their unique individual tastes in their purchase and use of one.

In summary, by utilizing a remote online server system providing dynamic virtual computing services in a subscription-based and server-based computing architecture, the invention eliminates the need for expensive components in the manufacture of personal computers, thereby significantly lowering the manufacturing cost. This cost savings can then be passed on to the end user or consumer. This also lowers the energy consumption the thin client device and the Pocket PC Phone do not need powerful processors and the negative environmental impact from the early and unneeded disposal of a larger mass of toxic electronic device waste. By providing access to the virtual computer from either the home thin client or the Pocket PC Phone, the user is provided with a unified virtual computing platform and can access it either from home or on the go. Furthermore, the ability to manufacture and customize a personal computer in a multitude of form factors, materials, or shapes that can be tailored to the different tastes and likes of people and for the PC to operate and interact with the user in ways that can be customized for individual user's tastes and likes will contribute to a unique, novel, convenient, and improved user experience with personal computers as well as give them the ability to express their unique individual tastes in their purchase and use of one.

Although the present invention has been described in detail with reference to one or more preferred embodiments, persons possessing ordinary skill in the art to which this invention pertains to will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of the claims.

### BRIEF DESCRIPTION OF THE DRAWINGS

FIG. 1 is a high level diagram of the system including the setup, composition, linkages, and relationships of the thin client and wireless mobile devices as well as the setup, composition, linkages, and relationships of the remote online server system.

FIG. 2 is a high level diagram of the remote online server system including the setup, composition, linkages, interactions, and relationships the server sub-groups, software programs, virtual computing instances, and subscription membership account screens.

FIG. 3A is an embodiment of the local hardware device (the thin client) in the shape of a mailbox. FIG. 3B shows the base underneath the grass slides out to provide access to the CD/DVD drive. The electronic input/output ports including power, network and television connections are located at the rear.

FIG. 4A is an embodiment of the local hardware device (the thin client) in the shape of a ‘Magic 8 Ball’. FIG. 4B shows the white circle portion (with the number 8 inside) opens up to provide access to the CD/DVD drive. The electronic input/output ports including power, network and television connections are located at the rear.

FIGS. 5A, 5B, and 5C show a high level diagram of the login and authentication communication sequence between the thin client device or Pocket PC Phone and the remote online server system.

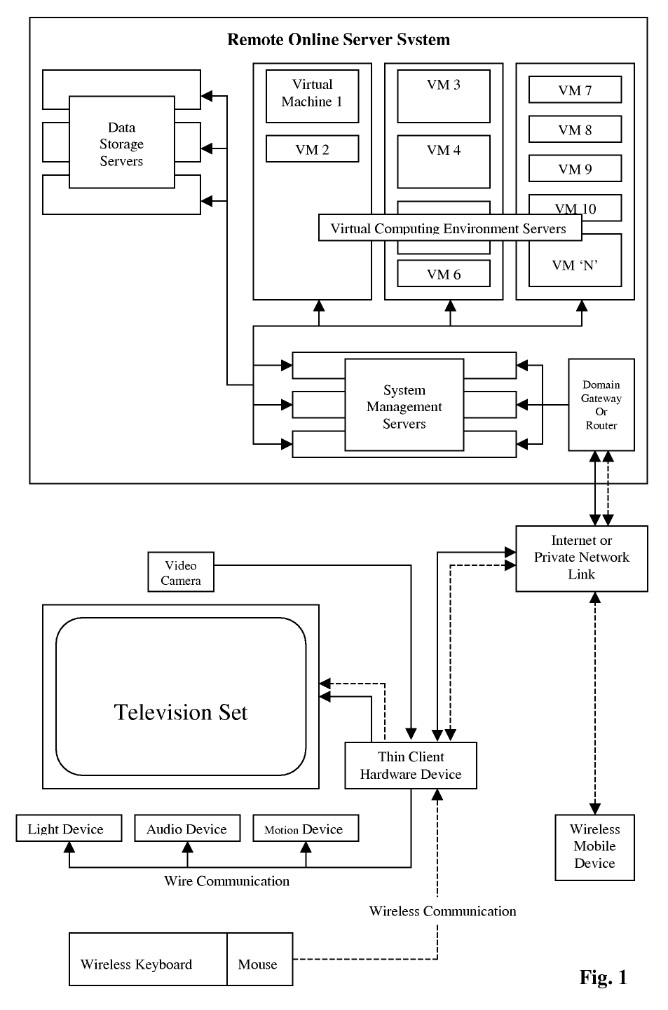

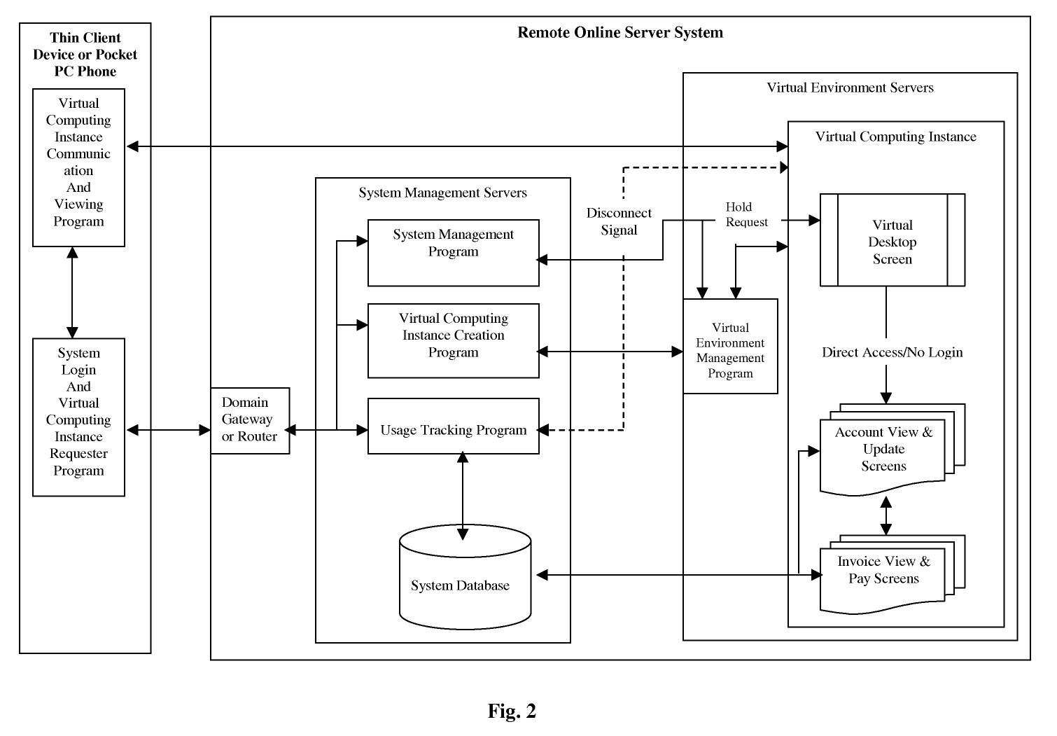

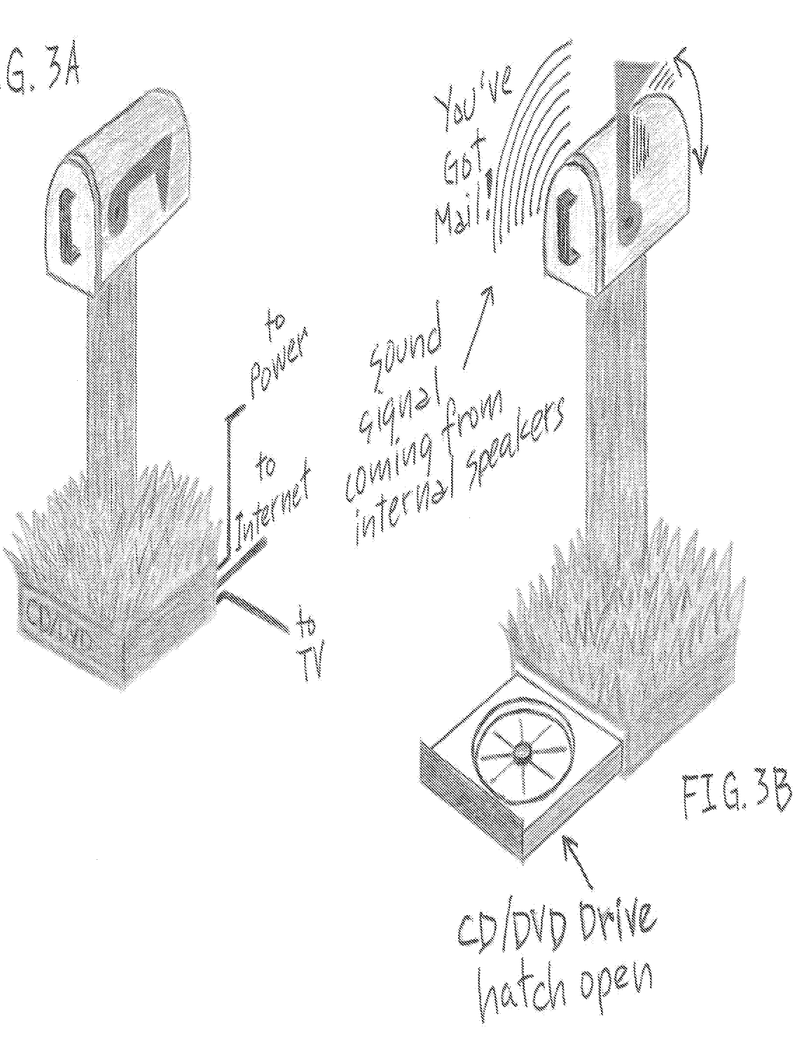

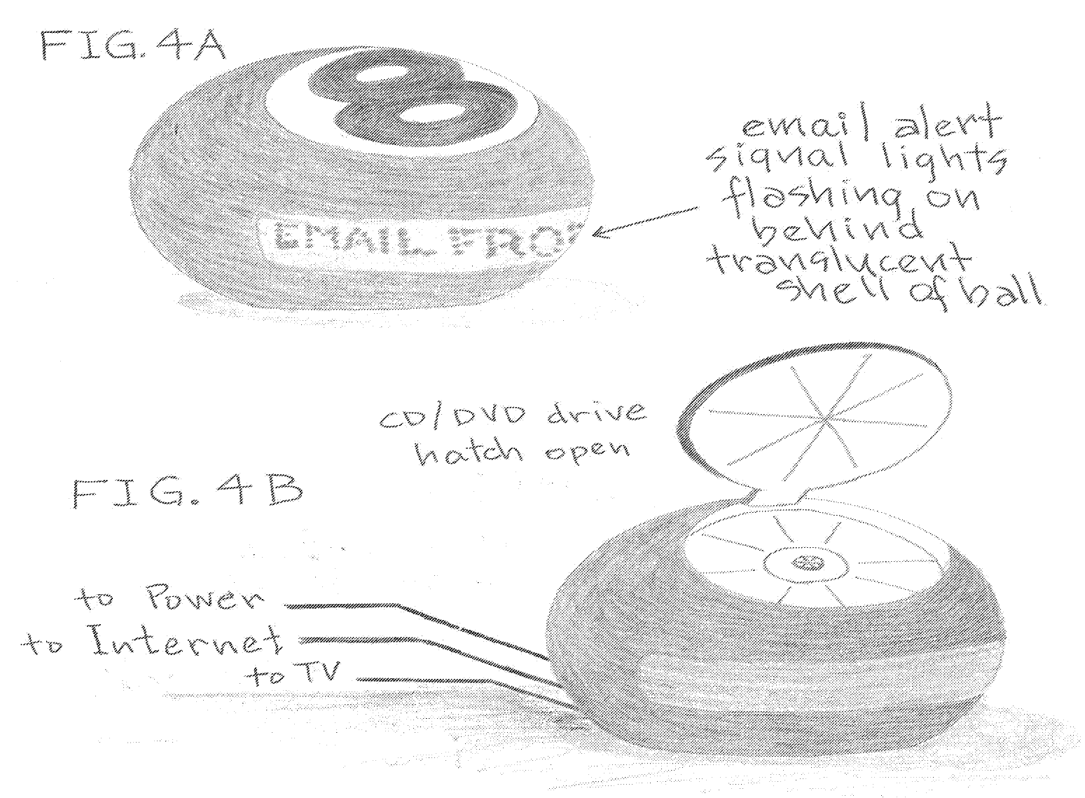

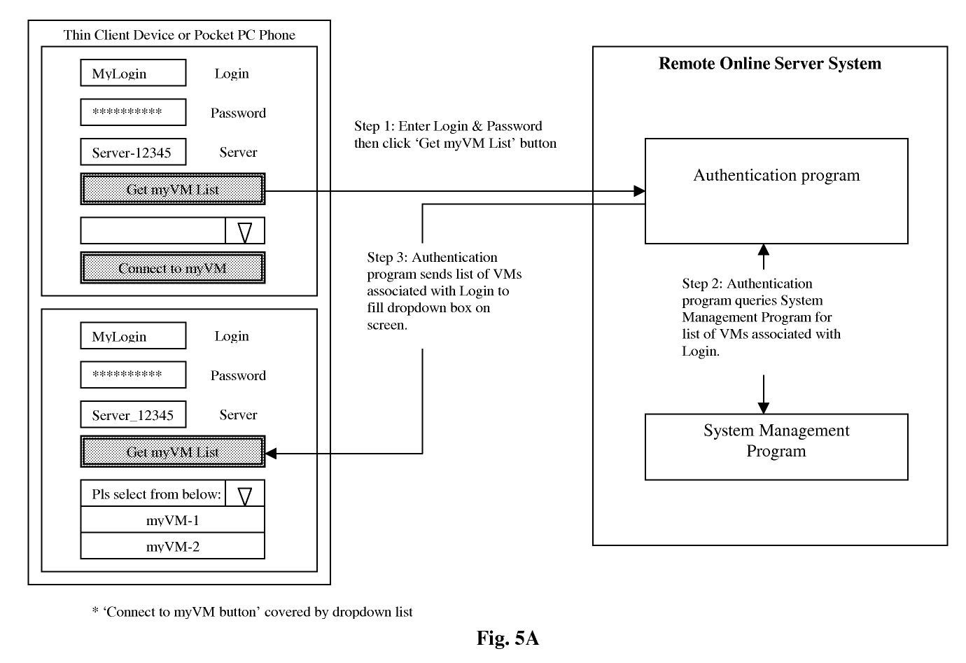

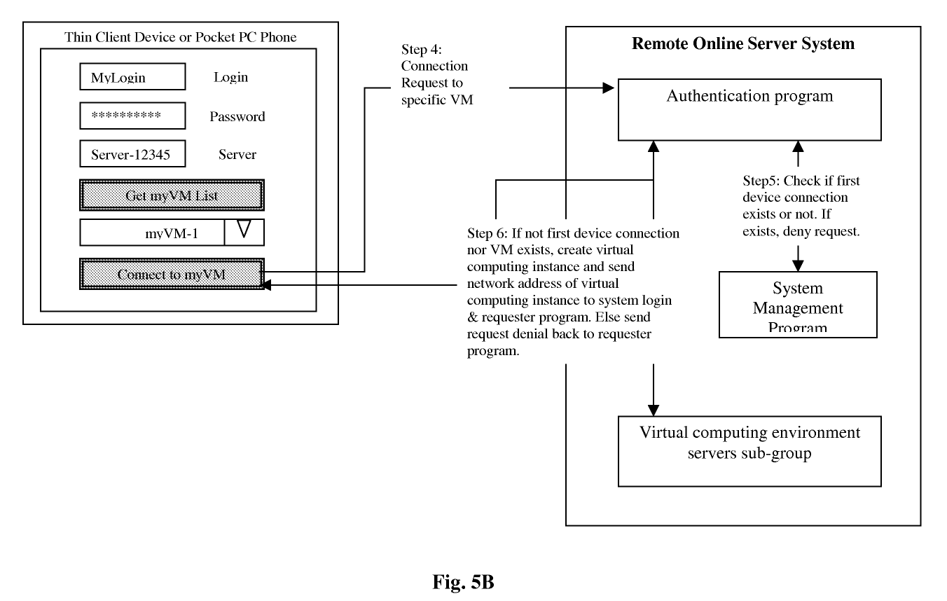

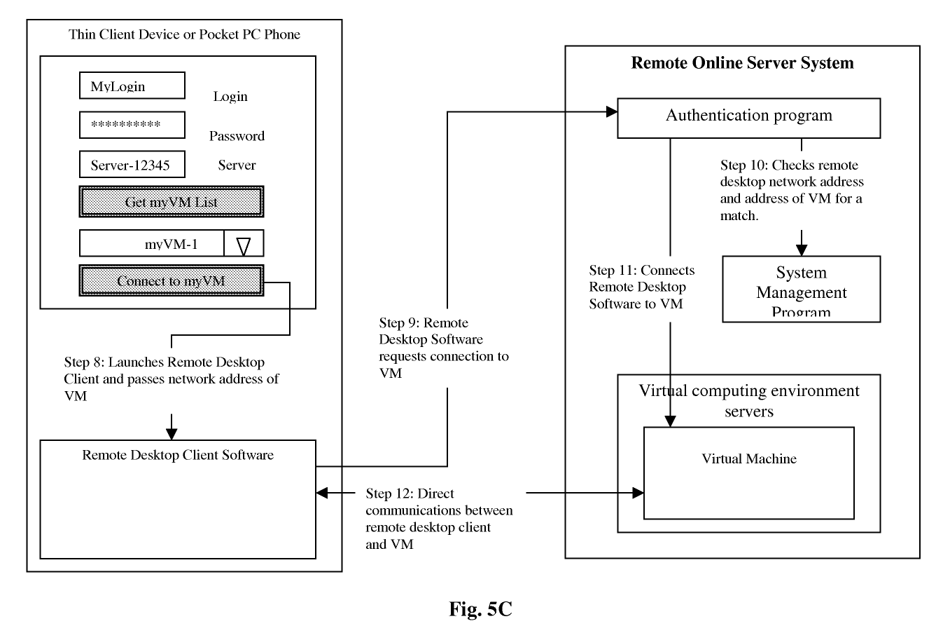

What is claimed is:

1. An electronic personal computing system including a remote online server system that creates and hosts a plurality of individual virtual desktop environments for each thin client device request, which provides remote thin client devices with personalized virtual subscription-based computing resources, computer programs such as email and web browsers, internet-based television programming, web-based video, television programming video card technology (e.g. ATI All-In-Wonder Radeon Pro Video Card), multi-location/multi-point video conferencing programs, and high-quality video & sound output.

2. An electronic personal computing system including a hardware thin client device composed of:
a) a housing with a plurality of form factor embodiments;
b) a housing created from a plurality of materials including but not limited to metal, wood, plastic, rubber, acrylic, cloth, stone, marble;
c) an electronic flash memory card or board;
d) electronic ports for input and output of light, audio, video, radio frequency, and motion signals.
e) built in light, motion and/or sound devices to emit custom and personalized light, motion and sound signals.

3. An electronic personal computing system including a wireless mobile device composed of:
a) a housing;
b) an electronic flash memory card and circuit board;
c) an attached keyboard & mouse;
d) an LCD screen
e) a microphone
f) a video camera
g) speakers
h) a wireless transceiver

4. The device of claim 1 wherein the device will be composed of several sub-groups of servers wherein each sub-group includes a plurality of physical server machines (a server farm) being harnessed and managed as a group to dynamically create and host a plurality of virtual computing environment instances in each physical server machine simultaneously, allowing a plurality of thin client devices to simultaneously request and receive computing, processing, and data services from each physical server machine.

5. A method of the device of claim 1 wherein a system management software program running on a central server specifically designated to manage the creation of virtual instances can apply logic to determine which physical server machine has the appropriate and enough computing, processing, or data storage resources required by each individual thin client request to ensure that the computing, processing, or data storage requests from the thin clients do not exceed the computing, processing, or data storage resources of each physical server machine.

6. A method of the device of claim 1 wherein a virtual computing instance dynamic creation program creates an instance of a virtual computing process dedicated and personalized for the device of claim 2 or 3 in one of the servers in the virtual computing environment server sub-group. It accomplishes this by communicating with a virtual computing environment management program located in each of the servers in the virtual computing environment server sub-group wherein a plurality of virtualization products are installed & running in one network. This allows multiple different virtualization products to by utilized by the virtual computing environment server sub-group.

7. The device of claim 1 wherein a software program sends video and/or audio data to the thin client device of claim 2 or 3 showing the current status or end result of its computing or processing request.

8. The device of claim 1 wherein a software program that will have logic to allow the user to request the system to hold and store a particular virtual computing instance in memory for a specified amount of time so that the user can be reconnect to that instance at a later time or switch devices and continue his or her session.

9. The device of claim 2 wherein the device:
a) is embodied in a plurality of form factors that are smaller and more varied in shape than the box shaped CPUs of current home personal computers;
b) may have built-in light, motion, and sound devices;
c) may have electronic output ports and interfaces for light, motion, and sound devices;
d) has a housing form factor that can be inserted into a larger housing form factor to power the larger housing unit via the electronic interfaces and/or ports;
e) provides output for CD/DVD drives, printers, and scanners.

10. Methods of the device of claim 2 wherein the device uses software programs to:
a) utilize a television set as the video output device;
b) receive user input via a wireless (WiFi, BlueTooth, Infrared, etc.) keyboard and a wireless mouse;
c) connect and communicate with a remote server system that provides the virtual personalized subscription-based computing, processing and data storage;
d) provide electronic output to light, motion, and sound devices;
e) provide electronic input & output for CD/DVD drives, printers, and scanners.

11. The device of claim 2 wherein the device may include a software program that converts the video output transmitted from the instance of the virtual computing environment into output compatible with the television (Component Video, S-Video, Composite Video, etc.) when the television does not allow input of computer video output (VGA or SVGA).

12. A method of the device of claim 2 wherein a software program will include functionality to choose from a plurality of internet and private network communication links including DSL, Cable, or other high speed broadband networks to connect to the device of claim 1 and these plurality of communication links will be an integral part of this invention's communication network. This network and system design feature lessens the risk of communication failure over a design where only one communication link is provided. With this design, in the case that one link is down, the software program can then choose from the other available communication links to connect to the device of claim 1.

13. A method of the device of claim 3 wherein a software program will include functionality to choose from a plurality of internet and private network communication links including DSL, Cable, or other high speed broadband networks to connect to the device of claim 1 and these plurality of communication links will be an integral part of this invention's communication network. This network and system design feature lessens the risk of communication failure over a design where only one communication link is provided. With this design, in the case that one link is down, the software program can then choose from the other available communication links to connect to the device of claim 1.

14. A method of the device of claim 2 wherein a system login and virtual computing instance requester program in the device establishes a first link communication with the device of claim 1 via a secure connection and protocol such as Secure Shell, Secure Sockets Layer (SSL), or Point to Point Tunneling Protocol via the internet or a private network with a gateway in the remote online server system which in turn communicates with an authentication program residing in the system management servers of the device of claim 1. The information transmitted in this first link communication can include the transmission of a device ID, a Login, and password that is unique to the entire system for authentication and tracking purposes. The device ID may include information unique to the device of claim 2. The authentication program then authenticates the connection request using the ID, Login, and Password against a list of existing customers in the system. The authentication program then queries the system accounts database to retrieve the virtual machine definitions for that particular login. This is a key feature since users are allowed to create a plurality of virtual machine configuration definitions that the user had previously defined and allows them to switch and connect to an instance of these virtual machines one at a time. This list of VMs is then sent to the system login and requester program running on either device of claim 2. The user can then choose from this list of virtual machine definitions and request to connect to it. When the user chooses a specific virtual machine definition and requests to connect to it, the system login & requester program establishes a second secure link communication with the authentication program of the device of claim 1. A section of the authentication and tracking logic records the ID, Login, Password, and network address of the device of claim 2 and queries the system management program to check whether another first device of either claim 2 is already connected and has a virtual computing session with the same login values, and if so denies the connection of the second device. This prevents users from establishing duplicate or multiple computing sessions by using both devices simultaneously. If the first device requested that the virtual computing instance to be held while the first device disconnects and the user switches devices and establishes a connection with a second device, then this is not a duplicate computing session and is therefore allowed by the system. Once this second secure link is established, a virtual computing instance creation program checks if a virtual computing instance personalized for each device is already running in one of the servers in the virtual computing environment server sub-group. If not, it dynamically creates a specific instance of that virtual computing instance. It accomplishes this by communicating with a virtual computing environment management program located in each of the servers in the virtual computing environment server sub-group. Once the virtual computing instance is created, the virtual computing instance creation program then sends the unique network address of the virtual machine to the device of claim 2. This unique network address is then received by the system login & requester program and passed to a virtual computing instance communication & viewing program (“remote desktop client software”). The remote desktop client software then communicates back to the authentication program to establish a connection to the virtual computing instance to utilize the computing, processing, and data storage services that it provides. The authentication program then verifies the network address of the device of claim 2 that the remote desktop program is running on and the network address of the virtual machine that it is requesting to connect to. This provides a layer of security and ensures that only authenticated requests get connected to their appropriate virtual machines.

15. A method of the device of claim 3 wherein a system login and virtual computing instance requester program in the device establishes a first link communication with the device of claim 1 via a secure connection and protocol such as Secure Shell, Secure Sockets Layer (SSL), or Point to Point Tunneling Protocol via the internet or a private network with a gateway in the remote online server system which in turn communicates with an authentication program residing in the system management servers of the device of claim 1. The information transmitted in this first link communication can include the transmission of a device ID, a Login, and password that is unique to the entire system for authentication and tracking purposes. The device ID may include information unique to the device of claim 3. The authentication program then authenticates the connection request using the ID, Login, and Password against a list of existing customers in the system. The authentication program then queries the system accounts database to retrieve the virtual machine definitions for that particular login. This is a key feature since users are allowed to create a plurality of virtual machine configuration definitions that the user had previously defined and allows them to switch and connect to an instance of these virtual machines one at a time. This list of VMs is then sent to the system login and requester program running on either device of claim 3. The user can then choose from this list of virtual machine definitions and request to connect to it. When the user chooses a specific virtual machine definition and requests to connect to it, the system login & requester program establishes a second secure link communication with the authentication program of the device of claim 1. A section of the authentication and tracking logic records the ID, Login, Password, and network address of the device of claim 3 and queries the system management program to check whether another first device of either claim 3 is already connected and has a virtual computing session with the same login values, and if so denies the connection of the second device. This prevents users from establishing duplicate or multiple computing sessions by using both devices simultaneously. If the first device requested that the virtual computing instance to be held while the first device disconnects and the user switches devices and establishes a connection with a second device, then this is not a duplicate computing session and is therefore allowed by the system. Once this second secure link is established, a virtual computing instance creation program checks if a virtual computing instance personalized for each device is already running in one of the servers in the virtual computing environment server sub-group. If not, it dynamically creates a specific instance of that virtual computing instance. It accomplishes this by communicating with a virtual computing environment management program located in each of the servers in the virtual computing environment server sub-group. Once the virtual computing instance is created, the virtual computing instance creation program then sends the unique network address of the virtual machine to the device of claim 3. This unique network address is then received by the system login & requester program and passed to a virtual computing instance communication & viewing program (“remote desktop client software”). The remote desktop client software then communicates back to the authentication program to establish a connection to the virtual computing instance to utilize the computing, processing, and data storage services that it provides. The authentication program then verifies the network address of the device of claim 3 that the remote desktop program is running on and the network address of the virtual machine that it is requesting to connect to. This provides a layer of security and ensures that only authenticated requests get connected to their appropriate virtual machines.

16. The device of claim 3 wherein the device accesses the same virtual computer accessed from the home based thin client, eliminating the need for the purchase and installation of a duplicate set of similar programs onto the device and for programs to synchronize data from the device of claim 3 with the device of claim 2.

17. The device of claim 1 wherein the device will include high-performance video card technology to provide fast and crisp image motion and refresh rates to the device of claim 2 or 3.

18. The device of claim 1 wherein pre-defined desktop environment templates that provide specific sets of subscription-based computer programs are offered for subscription and remote use.

19. The device of claim 1 wherein a software program will:
a) track usage by the device of claim 2 or 3, by recording the time and day of connection and disconnection.
b) create and present or transmit an invoice showing usage fees based on either minute or hourly usage by the device of claim 2 or 3, as well as other service and/or membership fees.
c) provide a graphical interface or screen is provided that allows the user to access their computing and data storage service subscription membership account information directly from their personal computer desktop screen without having to login again.

20. The device of claim 1 wherein the device allows the installation of computer programs into user's remote personal desktop environment utilizing local CD/DVD drive connected to device of claim 2 and have those programs saved as integral part of user's remote personal desktop environment settings and be able to be invoked, executed and used at a later date.
